(19) United States
(12) Patent Application Publication
(10) Pub. No.: US 2008/0212220 A1
(43) Pub. Date: Sep. 4, 2008

(54) Color filter substrate and method for manufacturing the same

(75) Inventors: Yi-Seop Shim, Gyeonggi-do (KR); Byoung-Joo Kim, Gyeonggi-do (KR); Jang-Sub Kim, Gyeonggi-do (KR); Yoon-Ho Kang, Gyeonggi-do (KR); Seong-Gyu Kwon, Gyeonggi-do (KR); Kwang-Ho Lee, Gyeonggi-do (KR); Chang-Hun Kwak, Gyeonggi-do (KR); Jae-Jun Yu, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 12/070,216

(22) Filed: Feb. 15, 2008

(30) Foreign Application Priority Data
Feb. 15, 2007 (KR) 10-2007-0016237

(51) Int. Cl. G02B 5/22; G02F 1/00

(52) U.S. Cl. 359/891; 430/7

(57) ABSTRACT

In a color filter substrate and a method for manufacturing the color filter substrate, the color filter substrate includes a base substrate, a first blocking pattern, a second blocking pattern and color filters. The base substrate includes a plurality of pixel areas. The first blocking pattern extends along a direction of the base substrate. The second blocking pattern crosses the first blocking pattern and includes a passage portion through which the base substrate is exposed to connect the pixel areas adjacent to each other along the direction. Color filters are formed in the pixel areas. Accordingly, the uniformity of the color filters and the reliability of the color filter's quality and manufacturing process may be enhanced so that display quality may be enhanced.

### CROSS-REFERENCE TO RELATED APPLICATIONS

This application claims priority under 35 U.S.C. § 119 to Korean Patent Application No. 2007-16237, filed on Feb. 15, 2007 in the Korean Intellectual Property Office (KIPO), the contents of which are herein incorporated by reference in their entirety.

### BACKGROUND OF THE INVENTION

1. Field of the Invention

The present invention relates to a color filter substrate and a method for manufacturing the color filter substrate. More particularly, the present invention relates to a color filter substrate used for a display apparatus and a method for manufacturing the color filter substrate.

2. Description of the Related Art

Generally, a display panel includes an array substrate, a color filter substrate and a liquid crystal layer. The array substrate has switching elements formed thereon. The color filter substrate has color filters formed thereon and is opposite to the array substrate. The liquid crystal layer is disposed between the array substrate and the color filter substrate. After a backlight incident into the display panel passes through the color filters of the display panel and a transmissivity of the backlight is changed, the colors of the backlight are mixed to display various colors. For example, the color filters include a red color filter, a green color filter and a blue color filter.

The color filters are manufactured via a dyeing process, a dispersion process, an electrodeposition process, a printing process, a jetting process and so on. When the jetting process is performed using an ink-jet printer, the manufacturing process of the color filters is simplified and manufacturing costs are decreased. However, the color filters manufactured via the jetting process have relatively low uniformity inside of a glass substrate and a display cell.

The low uniformity of the color filters is caused by different quantities of ink jetted by each nozzle of the ink-jet printer. When each nozzle of the ink-jet printer jets the ink of the different quantities, the quantities of color ink filled in pixel areas are changed so that a stain is displayed on the display panel. In addition, when the color ink is filled in an inner space corresponding to the color area defined by a blocking pattern, a surface of the color ink is bulged to have a dome shape due to a reactive force between the blocking pattern and the color ink and the surface tension of the color ink. Thus, a thickness of the color filter in a central portion is different from a thickness of the color filter in a peripheral portion so that an image in the central portion is displayed differently in the peripheral portion. Accordingly, the uniformity of the color filters deteriorates the display quality.

### SUMMARY OF THE INVENTION

Embodiments of the invention provide a color filter substrate enhancing the uniformity of color filters to enhance display quality.

Embodiments of the invention provide a method for manufacturing the color filter substrate enhancing the reliability of manufacturing processes.

In a color filter substrate according to an embodiment of the invention, the color filter substrate includes a base substrate, a first blocking pattern, a second blocking pattern and color filters. The base substrate includes a plurality of pixel areas. The first blocking pattern extends along a direction of the base substrate. The second blocking pattern crosses the first blocking pattern and includes a passage portion through which the base substrate is exposed to connect the pixel areas adjacent to each other along the direction. The color filters are formed in the pixel areas.

The color filter substrate may further include an organic pattern formed on the second blocking pattern and covering the passage portion corresponding to the second blocking pattern. The color filter substrate may further include a cell gap maintenance member connected to the organic pattern.

In another color filter substrate according to an embodiment of the invention, the color filter substrate includes a base substrate, a first blocking pattern, a second blocking pattern and color filters. The base substrate includes a plurality of pixel areas. The first blocking pattern extends along a direction of the base substrate. The second blocking pattern includes a dividing portion crossing the first pattern and a passage portion connected to the dividing portion and formed on the base substrate with a fourth thickness to connect the pixel areas adjacent to each other along the direction. The color filters are formed in the pixel areas.

In a method for manufacturing the color filter substrate according to an embodiment of the invention, a blocking layer is formed on a base substrate having a plurality of pixel areas. A first blocking pattern extending along a direction is formed via patterning the blocking layer. A second blocking pattern including a passage portion through which the base substrate is exposed to connect the pixel areas adjacent to each other along the direction is formed via patterning the blocking layer. Color filters are formed in each of the pixel areas using a print head.

According to an embodiment of the invention, a color filter substrate includes a second blocking pattern including a passage portion so that the uniformity of color filters formed using a print head may be enhanced. Thus, the quality of the color filters and the reliability of a manufacturing process of the color filters may be enhanced. Also, display quality may be enhanced.

### BRIEF DESCRIPTION OF THE DRAWINGS

The above and other features and advantages of the invention will become apparent by describing embodiments thereof with reference to the accompanying drawings, in which:

FIG. 1 is a plan view illustrating a display panel according to an embodiment of the invention;

FIG. 2 is a cross-sectional view taken along a line I-I′ and a line II-II′ of FIG. 2;

FIG. 3 is a plan view illustrating a color filter substrate according to another embodiment of the invention;

FIG. 4 is a cross-sectional view taken along a line III-III′ of FIG. 3;

FIG. 5 is a plan view illustrating a color filter substrate according to another embodiment of the invention;

FIG. 6 is a cross-sectional view taken along a line IV-IV′ of FIG. 5; and

FIGS. 7A to 12 are sectional views illustrating an embodiment of a process for manufacturing a color filter substrate.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments as set forth herein. Rather, these embodiments are provided so that this disclosure will be thorough and complete and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of the invention.

Spatially relative terms, such as “beneath,” “below,” “lower,” “above,” “upper” and the like, may be used herein for ease of description to describe one element or feature's relationship to another element(s) or feature(s) as illustrated in the drawings. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing particular embodiments and is not intended to limit the scope of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. In one aspect, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the invention will be explained in detail with reference to the accompanying drawings.

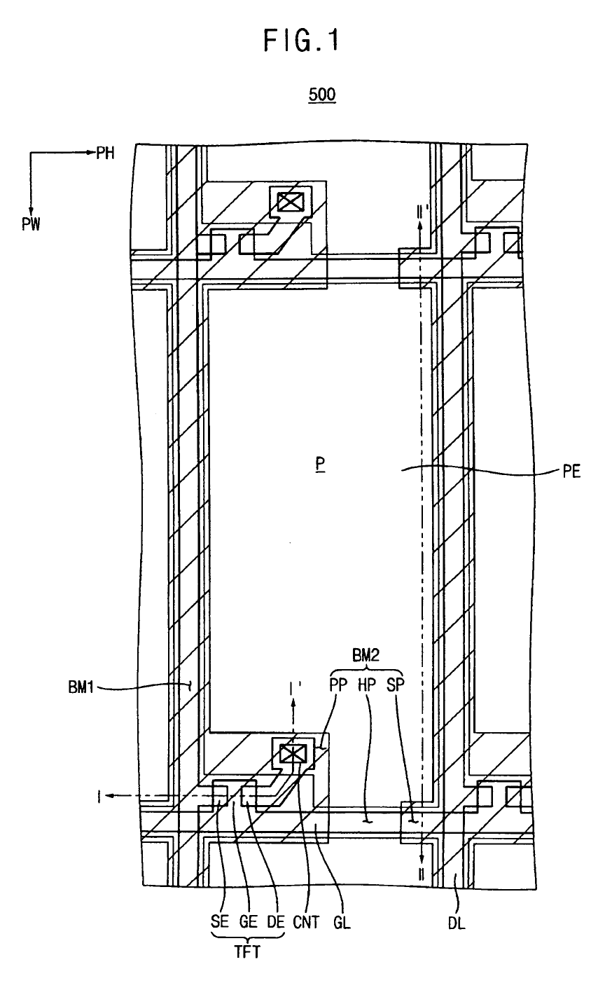

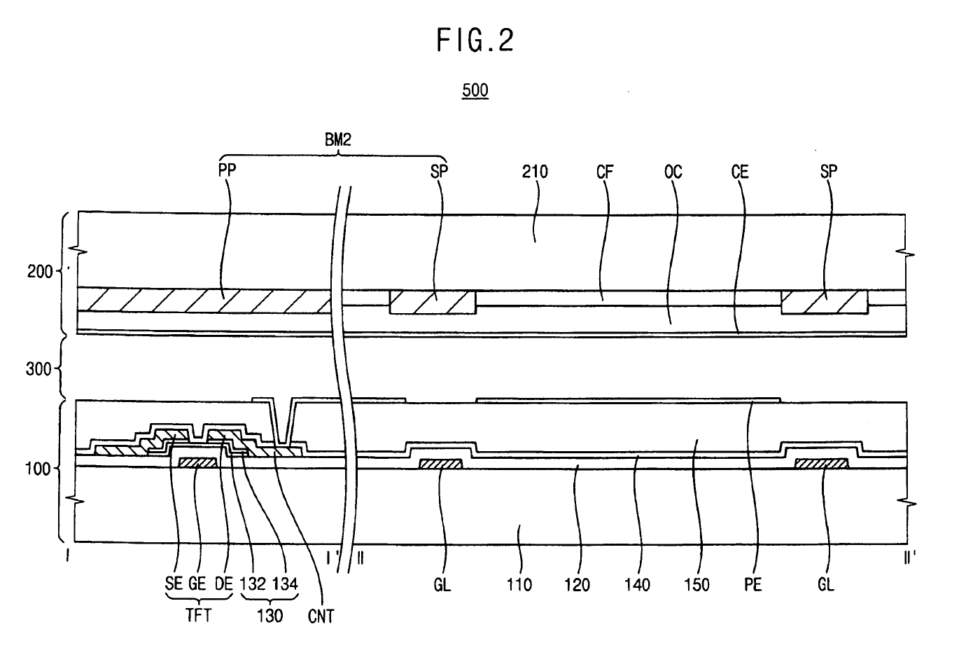

FIG. 1 is a plan view illustrating a display panel according to an embodiment of the invention. FIG. 2 is a cross-sectional view taken along a line I-I′ and a line II-II′ of FIG. 2.

Referring to FIGS. 1 and 2, a display panel 500 according to one embodiment includes an array substrate 100 that is a lower substrate, a color filter substrate 200 that is an upper substrate opposite to the lower substrate, and a liquid crystal layer 300 interposed between the array substrate 100 and the color filter substrate 200.

The array substrate 100 includes a gate line GL, a source line DL, a thin-film transistor (TFT) that is a switching element electrically connected to the gate and source lines GL and DL, and a pixel electrode PE electrically connected to the TFT, which are formed on a first base substrate 110. A pixel area P is defined on the array substrate 100.

The gate line GL extends along a first direction PH of the first base substrate 110, and a plurality of gate lines GL is disposed substantially parallel with a second direction PW substantially perpendicular to the first direction PH. The source line DL extends along the second direction PW, and a plurality of source lines DL is disposed substantially parallel with the first direction PH. The TFT includes a gate electrode GE electrically connected to the gate line GL, a source electrode SE formed on the gate electrode GE and electrically connected to the source line DL, and a drain electrode DE spaced apart from the source electrode SE. An end portion CNT of the drain electrode DE makes contact with the pixel electrode PE so that the TFT is electrically connected to the pixel electrode PE.

The array substrate 100 may further include a gate insulating layer 120, a semiconductor pattern 130, a passivation layer 140 and an organic insulating layer 150. The gate insulating layer 120 is formed on the gate line GL and the gate electrode GE. The semiconductor pattern 130 is formed on the gate insulating layer 120 corresponding to the gate electrode GE. A semiconductor layer 132 and an ohmic contact layer 134 are sequentially formed to form the semiconductor pattern 130. The passivation layer 140 and the organic insulating layer 150 are sequentially formed on the gate insulating layer 120 to cover the source line DL, the source electrode SE electrically connected to the source line DL, and the drain electrode DE.

The color filter substrate 200 includes a first blocking pattern BM1 opposite to the array substrate 100 and formed on a second base substrate 210, a second blocking pattern BM2, a color filter CF, an overcoating layer OC, and a common electrode layer CE. The first and second blocking patterns BM1 and BM2 enclose the pixel area P of the second base substrate 210. The first and second blocking patterns BM1 and BM2 cross each other to form a lattice shape.

The first blocking pattern BM1 sequentially extends along the second direction PW and is disposed substantially parallel with the first direction PH. In one aspect, the first blocking pattern BM1 may correspond to the source line DL of the array substrate 100. The first blocking pattern BM1 divides the pixel areas disposed adjacent to each other.

The second blocking pattern BM2 extends along the first direction PH and is disposed substantially parallel with the second direction PW. The second blocking pattern BM2 includes a dividing portion SP and a passage portion HP. The dividing portion SP extends along the first direction PH to cross the first blocking pattern BM1. The passage portion HP separates the dividing portion SP to partially connect the pixel area P. The passage portion HP may connect the pixel area P with an adjacent pixel area. The passage portion HP separates the dividing portion SP to expose the second base substrate 210. In one aspect, the second blocking pattern BM2 corresponds to the gate lines GL of the array substrate 100.

The second blocking pattern BM2 includes a cover portion PP corresponding to the TFT of the array substrate 100. The cover portion PP blocks light incident into the TFT to prevent a light leakage current of the TFT. The cover portion PP may be protruded from the dividing portion SP along the second direction PW. In one aspect, the cover portion PP may be adjacent to a crossing point of the first and second blocking patterns BM1 and BM2. The cover portion PP depends on a position and a size of the TFT.

The color filter CF is formed in each pixel area P of the second base substrate 210. The color filter CF may transmit a backlight provided from a lower portion of the array substrate to the color filter substrate 200 to display a color image on the display panel 500. In one aspect, the color filter CF may include one of a red color, a green color and a blue color. A color ink is injected onto the pixel area P to form the color filter CF. The color ink injected onto the passage portion HP may connect the color filters CF that are disposed adjacent to each other and have substantially the same color. In the process of injecting the color ink onto the pixel area P and the passage portion HP, the color ink is sequentially injected along a direction, such as, for example, the second direction PW, using a print head, and then the color ink may be uniformly injected over the pixel areas adjacent to each other along the second direction PW through the passage portion.

When the pixel area P does not include the passage portion HP, a surface of the color ink injected onto the pixel area P is partially bulged to have a dome shape along the first and second directions PH and PW. In one embodiment, the color ink is a fluid having a viscosity coefficient between about 6 cp and about 15 cp and/or a surface tension between about 25 N/m and about 35 N/m so that the dome shape may be formed. In one embodiment, the pixel areas adjacent to each other are opened through the passage portion HP to be connected to each other so that the color ink may be uniformly distributed over the pixel areas.

Accordingly, thickness uniformity of the adjacent color filters having substantially the same color may be increased, and the color filter CF in the pixel area P is prevented from having the dome shape along the second direction PW. Thus, the quality of the color filter may be enhanced and display quality may be enhanced. Furthermore, the passage portion HP partially opens the pixel areas disposed adjacent to each other to control a flow of the color ink along the second direction PW.

The overcoating layer OC is formed on the second base substrate 210, on which the first and second blocking patterns BM1 and BM2 and the color filter substrate CF are formed. The common electrode layer CE is formed on the second base substrate 210, on which the overcoating layer OC is formed. The common electrode layer CE faces the pixel electrode PE of the array substrate 100 to receive a common voltage.

Although not shown in the figure, the display panel 500 may further include a spacer. The space is disposed between the array substrate 100 and the color filter substrate 200 to uniformly maintain a distance between the array substrate 100 and the color filter substrate 200. The spacer may be formed on one of the array substrate 100 and the color filter substrate 200.

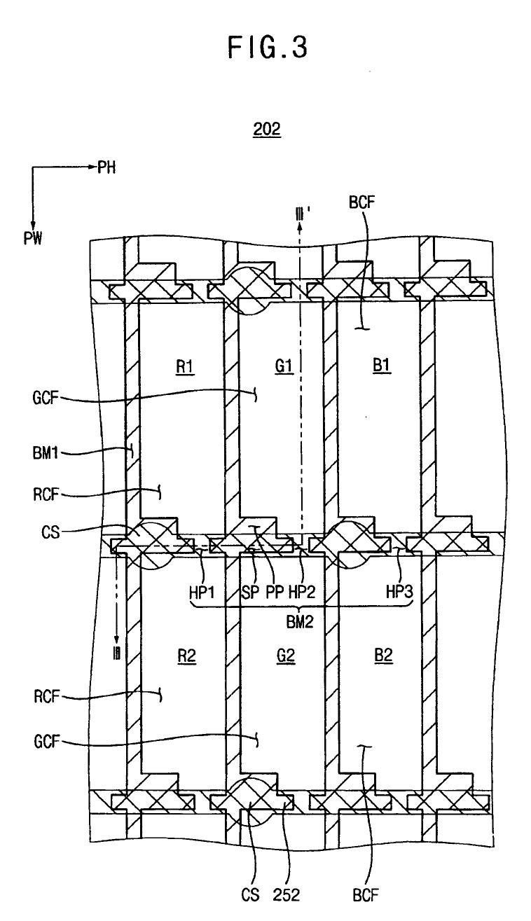

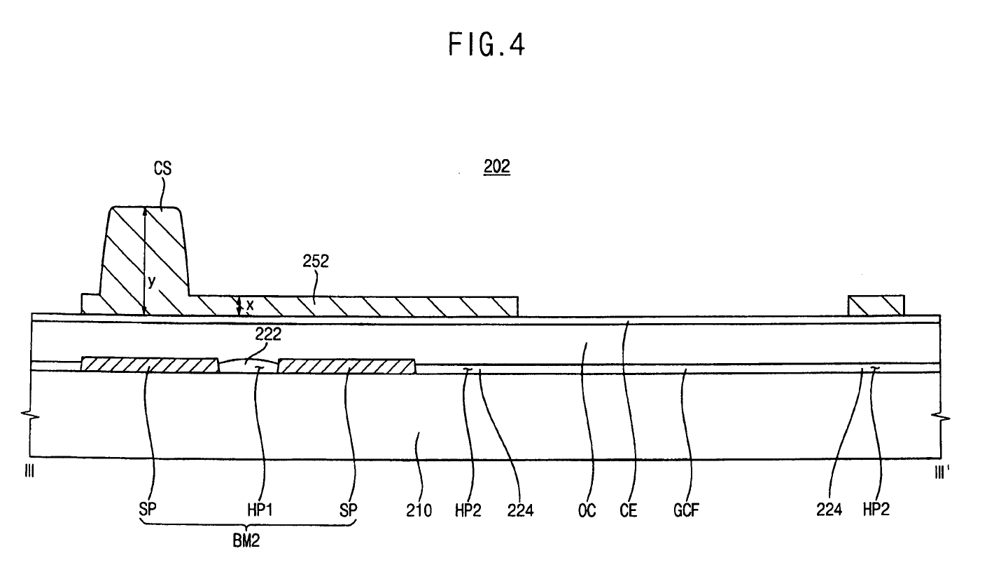

FIG. 3 is a plan view illustrating a color filter substrate according to an embodiment of the invention. FIG. 4 is a cross-sectional view taken along a line III-III′ of FIG. 3.

The color filter substrate according to the embodiment of FIGS. 3 and 4 is substantially the same as the color filter substrate according to the embodiment illustrated in FIGS. 1 and 2. Thus, it should be appreciated that the same reference numerals will be used to refer to the same or like parts as those described in the embodiment illustrated in FIGS. 1 and 2, and any further repetitive explanation concerning the above elements will be omitted to simplify the following discussion.

The color filter substrate 202 according to one embodiment includes color filters having first, second and third colors RCF, GCF and BCF, but the color filter substrate 202 may further include color filters having more than four colors different from each other.

Referring to FIGS. 3 and 4, the color filter substrate 202 according to one embodiment includes a first blocking pattern BM1 formed on the second base substrate 210, a second blocking pattern BM2, the color filters RCF, GCF and BCF, an overcoating layer OC, a common electrode layer CE, an organic pattern 252 and a cell gap maintenance member CS.

The first and second blocking patterns BM1 and BM2 surround a plurality of pixel areas R1, R2, G1, G2, B1 and B2 of the second base substrate 210. The first blocking pattern BM1 sequentially extends along the second direction PW. The second blocking pattern BM2 extends along the first direction PH and is disposed substantially parallel with the second direction PW. The pixel areas, in which the first color filters RCF are formed, are defined as first pixel areas R1 and R2. The pixel areas, in which the second color filters GCF are formed, are defined as second pixel areas G1 and G2. The pixel areas, in which the third color filters BCF are formed, are defined as third pixel areas B1 and B2. In addition, a passage portion formed in the second blocking pattern BM2 between the first pixel areas R1 and R2 adjacent to each other is defined as a first passage portion HP1. A passage portion formed in the second blocking pattern BM2 between the second pixel areas G1 and G2 adjacent to each other is defined as a second passage portion HP2. A passage portion formed in the second blocking pattern BM2 between the third pixel areas B1 and B2 adjacent to each other is defined as a third passage portion HP3.

A first color ink is injected onto the first pixel areas R1 and R2 to form the first color filters RCF. The second color ink is injected onto the second pixel areas G1 and G2 to form the second color filters GCF. In addition, the third color ink is injected onto the third pixel areas B1 and B2 to form the third color filters BCF.

The adjacent first pixel areas R1 and R2 are connected along the second direction PW through the first, second and third passage portions HP1, HP2 and HP3. The adjacent second pixel areas G1 and G2 are connected along the second direction PW through the first, second and third passage portions HP1, HP2 and HP3. In addition, the adjacent third pixel areas B1 and B2 are connected along the second direction PW through the first, second and third passage portions HP1, HP2 and HP3. Thus, a nozzle of the print head corresponding to each pixel area may sequentially inject the color ink. Alternatively, the nozzle of the print head corresponding to each pixel area may intermittently inject the color ink.

The first color ink sequentially injected onto the first pixel areas R1 and R2 and the first passage portion HP1 forms the first color filters RCF and connects the first color filters RCF with each other. The second color ink sequentially injected onto the second pixel areas G1 and G2 and the second passage portion HP2 forms the second color filters GCF and connects the second color filters GCF with each other. The third color ink sequentially injected onto the third pixel areas B1 and B2 and the third passage portion HP3 forms the third color filters BCF and connects the third color filters BCF with each other.

As illustrated in FIG. 4, in the cross-sectional view illustrating the first passage portion HP1 taken along the first direction PH, the first color ink 222 may be injected onto the first passage portion HP1 to form the dome shape in the first passage portion HP1 along the first direction PH. However, in the cross-sectional view illustrating the second pixel area G1 and the second passage portion HP2 taken along the second direction PW, the second color ink 224 may be smoothly injected onto the second pixel area G1 and the second passage portion HP2. Accordingly, the second color filter GCF may be smoothly formed in the second pixel area G2 along the second direction PW.

The first, second and third passage portions HP1, HP2 and HP3 of the second blocking pattern BM2 may prevent each of the first, second and third color filters RCF, GCF and BCF from having the dome shape along the second direction PW. In one aspect, the first, second and third color inks may be uniformly injected over the adjacent pixel areas along the second direction PW through the first, second and third passage portions HP1, HP2 and HP3 so that the color filters may be smoothly formed.

The overcoating layer OC is formed on the second base substrate 210 having the first and second blocking patterns BM1 and BM2 and the color filters RCF, GCF and BCF. The overcoating layer OC may be omitted. The common electrode layer CE is formed on the second base substrate 210 having the first and second blocking patterns BM1 and BM2 and the color filters RCF, GCF and BCF. The common electrode layer CE may be formed on the overcoating layer OC.

The organic pattern 252 is formed on the second base substrate 210, on which the common electrode layer CE is formed. The organic pattern 252 corresponds to the second blocking pattern BM2. The organic pattern 252 covers the first, second and third passage portions HP1, HP2 and HP3 to prevent light leakage that may be caused by the first, second and third passage portions HP1, HP2 and HP3. The organic pattern 252 is formed on the second blocking pattern BM2 with a first thickness x. The organic pattern 252 may correspond to the first and second blocking patterns BM1 and BM2.

The cell gap maintenance member CS is connected to the organic pattern 252 to correspond to the second blocking pattern BM1. The cell gap maintenance member CS is disposed between the upper and lower substrates to uniformly maintain a distance between the upper and lower substrates. The cell gap maintenance member CS is connected to the organic pattern 252 so that a resistance against compression of the cell gap maintenance member CS between the array substrate 100 and the color filter substrate 200 may be enhanced. In one aspect, the cell gap maintenance member CS may be prevented from collapsing and may be easily restored after external force is removed. The cell gap maintenance member CS may be formed on the cover portion PP to correspond to the cover portion PP. The cell gap maintenance member CS corresponds to the cover portion PP to have a second thickness y thicker than the first thickness x. A plurality of cell gap maintenance members CS may be disposed on the color filter substrate 202. In this case, the number of the cell gap maintenance members CS may be controlled considering a margin of a liquid crystal injection process.

According to the above-mentioned embodiments of the invention, the color ink may be sequentially injected onto the second base substrate 210 through the nozzle of the print head. Thus, the thickness uniformity of the color filters disposed adjacent to each other along the second direction PW may be increased. Accordingly, the display quality of the display panel may be enhanced. In addition, the organic pattern 252 of the color filter substrate 202 covers the first, second and third passage portions HP1, HP2 and HP3 to prevent the light leakage. The organic pattern 252 may enhance the resistance against the compression of the cell gap maintenance member CS.

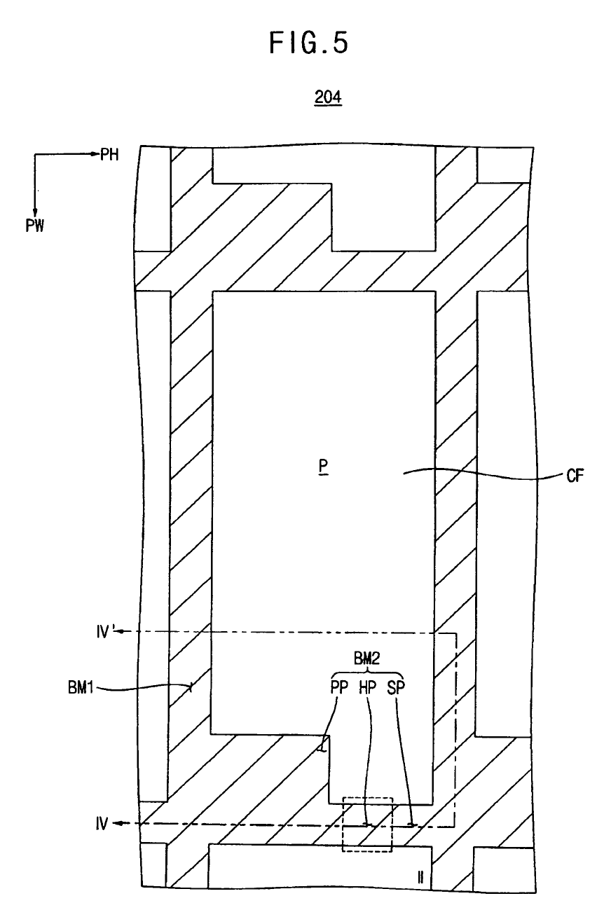

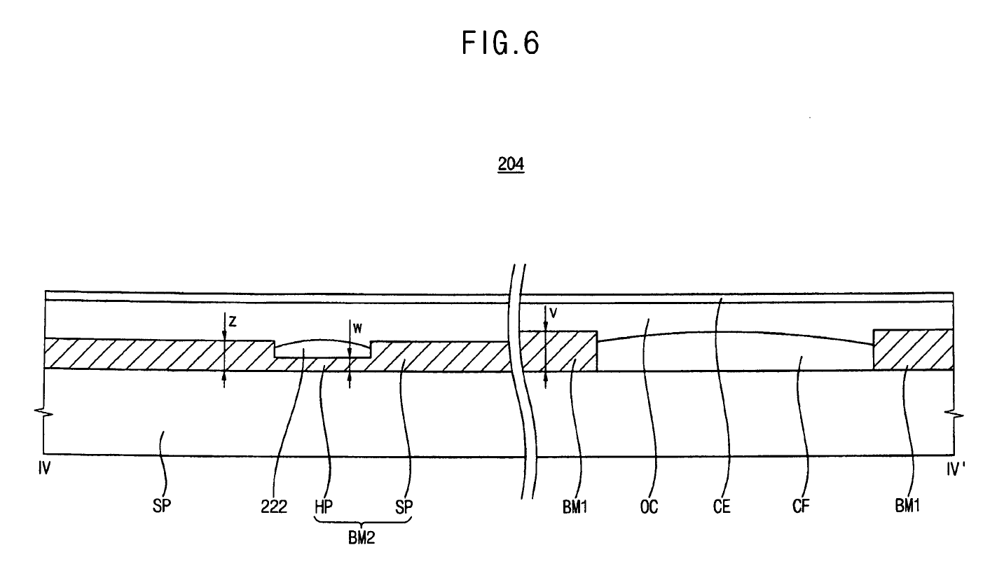

FIG. 5 is a plan view illustrating a color filter substrate according to another embodiment of the invention. FIG. 6 is a cross-sectional view taken along a line IV-IV′ of FIG. 5.

Referring to FIGS. 5 and 6, the color filter substrate 504 according to one embodiment includes a first blocking pattern BM1, a second blocking pattern BM2, a color filter CF, an overcoating layer OC and a common electrode layer CE, which are formed on the second base substrate 210.

The first and second blocking patterns BM1 and BM2 surround the pixel portion P of the second base substrate 210. The first and second blocking patterns BM1 and BM2 cross each other to form the lattice shape. The first blocking pattern BM1 sequentially extends along the second direction PW and is disposed substantially parallel with the first direction PH substantially perpendicular to the second direction PW. The first blocking pattern BM1 divides the pixel areas disposed adjacent to each other.

The second blocking pattern BM2 extends along the first direction PH and is disposed substantially parallel with the second direction PW. The second blocking pattern BM2 includes a dividing portion SP and a passage portion HP. The dividing portion SP crosses the first blocking pattern BM1 and is formed on the second base substrate 210 with a third thickness z. The passage portion HP has a fourth thickness w smaller than the third thickness z of the dividing portion SP. In one embodiment, the fourth thickness w is over 0 μm. The passage portion HP is thinner than the dividing portion SP so that the color ink may flow into a pixel area adjacent to the pixel area P through the passage portion HP. The passage portion HP is formed on the second base substrate 210 to have the fourth thickness w so that an additional blocking member covering the passage portion HP may be omitted.

In one embodiment, the third thickness z of the dividing portion SP may be substantially same or may be greater than the sum of the fourth thickness w of the passage portion HP and the thickness of the color ink injected onto the passage portion HP. The first blocking pattern BM1 is formed on the second base substrate 210 with a fifth thickness v. The fifth thickness v of the first blocking pattern BM1 may be thicker than the third thickness z of the second blocking pattern BM2. Alternatively, the fifth thickness v of the first blocking pattern BM1 may be formed substantially same as the third thickness z of the second blocking pattern BM2.

Accordingly, the color ink may flow through the passage portion HP so that the color filters CF formed in the adjacent pixel areas may be formed with uniform thickness and may be prevented from having the dome shape along the second direction PW. At the same time, the dividing portion SP crosses the first blocking pattern BM1 to control the flow of the color ink.

The overcoating layer OC is formed on the second base substrate 210, on which the first and second blocking patterns BM1 and BM2 and the color filter CF are formed. The common electrode layer CE is formed on the second base substrate 210 having the overcoating layer PC. The first and second blocking patterns BM1 and BM2 according to the present example embodiment totally surround the pixel area P so that an additional blocking member covering the passage portion HP may be omitted.

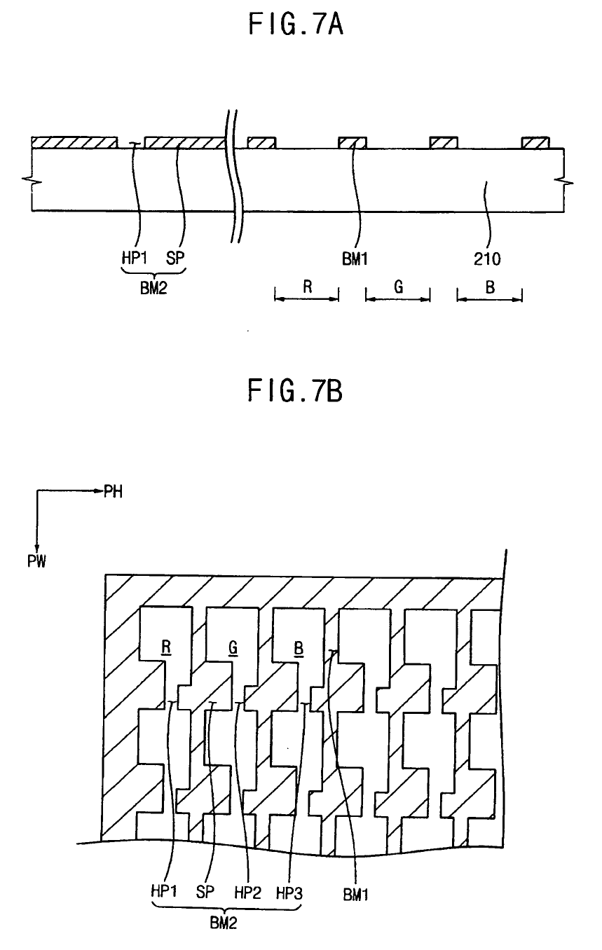

FIGS. 7A to 12 are sectional views illustrating an embodiment of a process for manufacturing a color filter substrate.

FIG. 7A is a cross-sectional view illustrating a process for forming the first and second blocking patterns on the second base substrate. FIG. 7B is a plan view illustrating the process in FIG. 7A.

Referring to FIGS. 3, 7A and 7B, an organic material is coated on the second base substrate 210 to form a blocking layer (not shown), and the blocking layer is patterned to form the first and second blocking patterns BM1 and BM2.

The first blocking pattern BM1 sequentially extends along the second direction PW and is disposed substantially parallel with the first direction PH substantially perpendicular to the second direction PW. The first blocking pattern BM1 divides pixel areas R, G and B disposed adjacent to each other along the first direction PH. The second blocking pattern BM2 crosses the first blocking pattern BM1, extends along the first direction PH and is disposed substantially parallel with the second direction PW. The second blocking pattern BM2 includes the first, second and third passage portions HP1, HP2 and HP3 separating the dividing portion SP crossing the first blocking pattern BM1 and connecting the pixel areas disposed adjacent to each other along the second direction PW. The first, second and third passage portions HP1, HP2 and HP3 expose the second base substrate 210. The cross-sectional view of the first passage portion HP1 taken along the first direction PH is illustrated in FIG. 7A, but cross-sectional views of the first and second passage portions HP2 and HP3 may be substantially same as the cross-sectional view of the first passage portion HP1.

Accordingly, the first, second and third passage portions HP1, HP2 and HP3 may be formed on the second base substrate 210 with the fourth thickness was the passage portion HP of the color filter substrate 204 illustrated in FIGS. 5 and 6. In FIGS. 3, 7A and 7B, a mask having a slit or a half tone may be used to form the passage portion HP to have the fourth thickness w smaller than the third thickness z.

The blocking layer having the organic material is formed on the second base substrate 210 and is patterned to form the first and second blocking patterns BM1 and BM2. Alternatively, the first and second blocking patterns BM1 and BM2 may include a metal. The first and second blocking patterns BM1 and BM2 according to an embodiment of the invention are formed thicker than in the case of forming the color filter using a color photoresist to prevent overflow of the color ink.

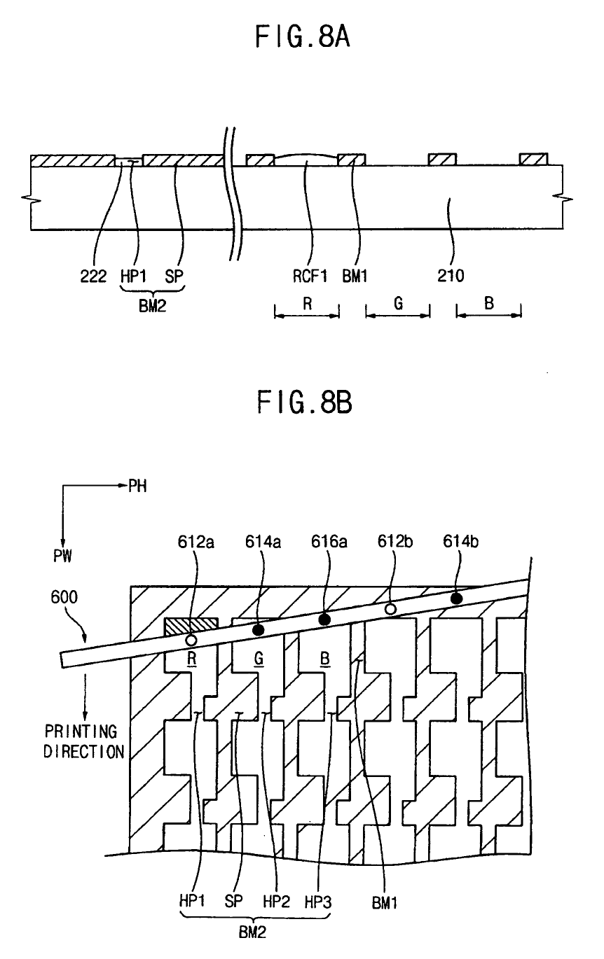

FIG. 8A is a cross-sectional view illustrating a process for forming the first color filters on the second base substrate. FIG. 8B is a plan view illustrating the process in FIG. 8A.

Referring to FIGS. 8A and 8B, among the plurality of the pixel areas R, G and B of the second base substrate 210, on which the first and second blocking patterns BM1 and BM2 are formed, the first color filters RCF are formed in the first pixel areas R.

The first color ink is injected onto the first pixel areas R using a first print head 600 to form the first color filters RCF. The first color ink may be sequentially injected onto the first pixel areas R and the first passage portion HP1 connecting the first pixel areas R, using the nozzle of the first print head 600. The first print head 600 sequentially injects the first color ink so that the first color ink 222 injected onto the first passage portion HP1 connects the first color filters RCF formed in the first pixel areas R disposed adjacent to each other. In addition, the first color ink injected onto the first pixel areas R may flow along the second direction PW through the first passage portion HP1.

The first print head 600 includes a plurality of nozzles 612a, 614a, 616a, 612b and 614b. The first color ink is injected onto the first pixel areas R using the nozzles corresponding to the first pixel areas R as emitting nozzles among the nozzles 612a, 614a, 616a, 612b and 614b to form the first color filters RCF. For example, as illustrated in FIG. 8B, the first color ink may be injected using (3 k−2)-th nozzles 612a and 612b of the first print head 600 as the emitting nozzles to form the first color filters RCF. In FIGS. 8A and 8B, the first color ink may not be injected through (3 k−1)-th nozzles 614a and 614b and (3k)-th nozzles 616a.

The first color ink may be injected along a direction according to a movement of one of the first print head 600 and the second base substrate 210. In one aspect, the direction, that is a printing direction, may be substantially parallel with the second direction PW, along which the first blocking pattern BM1 extends. Alternatively, the first color ink may be firstly injected along the second direction PW, and then, the first color ink may be secondly injected along a direction opposite to the second direction PW to form the first color filters RCF.

The first color ink is sequentially injected along the second direction PW using the first print head 600 so that the thickness of the first color filters RCF may be uniformized. In addition, the first pixel areas R are opened along the second direction PW through the first passage portion HP1 so that the first color inks may be prevented from having the dome shape along the second direction PW. Accordingly, the thickness uniformity of the first color filters RCF, that are formed in the first pixel areas R disposed adjacent to each other along the second direction PW, may be increased.

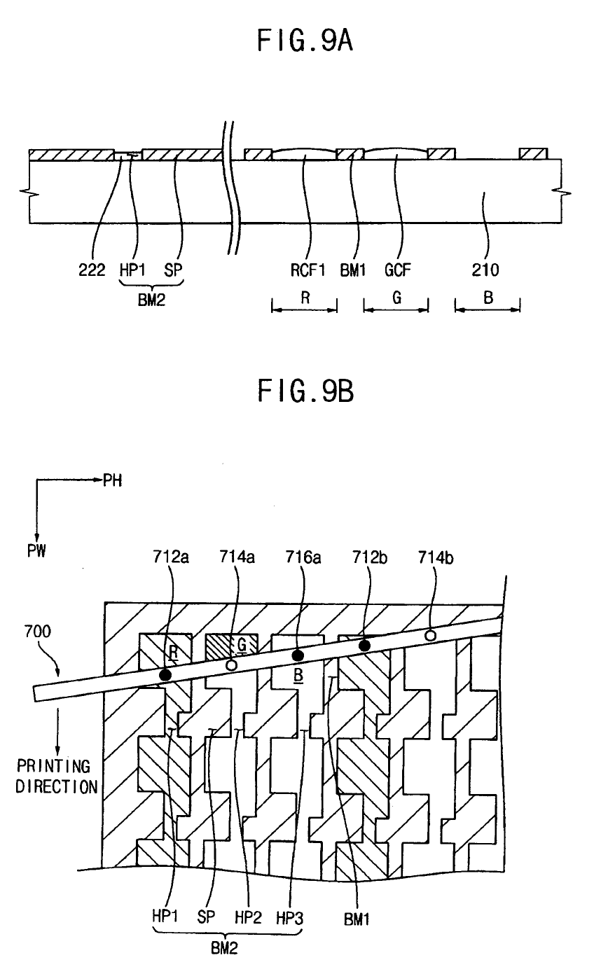

FIG. 9A is a cross-sectional view illustrating an embodiment of a process for forming the second color filters on the second base substrate. FIG. 9B is a plan view illustrating the process in FIG. 9A.

Referring to FIGS. 9A and 9B, the second color filters GCF are formed in the second pixel areas G of the second base substrate 210, on which the first color filters RCF are formed.

The second color ink is injected onto the second pixel areas G using a second print head 700 to form the second color filters GCF. The second color ink may be sequentially injected onto the second pixel areas G and the second passage portion HP2 connecting the second pixel areas G using a nozzle of the second print head 700.

The second print head 700 includes a plurality of nozzles 712a, 714a, 716a, 712b and 714b. The second color ink is injected onto the second pixel areas G using the nozzles corresponding to the second pixel areas G as emitting nozzles among the nozzles 712a, 714a, 716a, 712b and 714b to form the second color filters GCF.

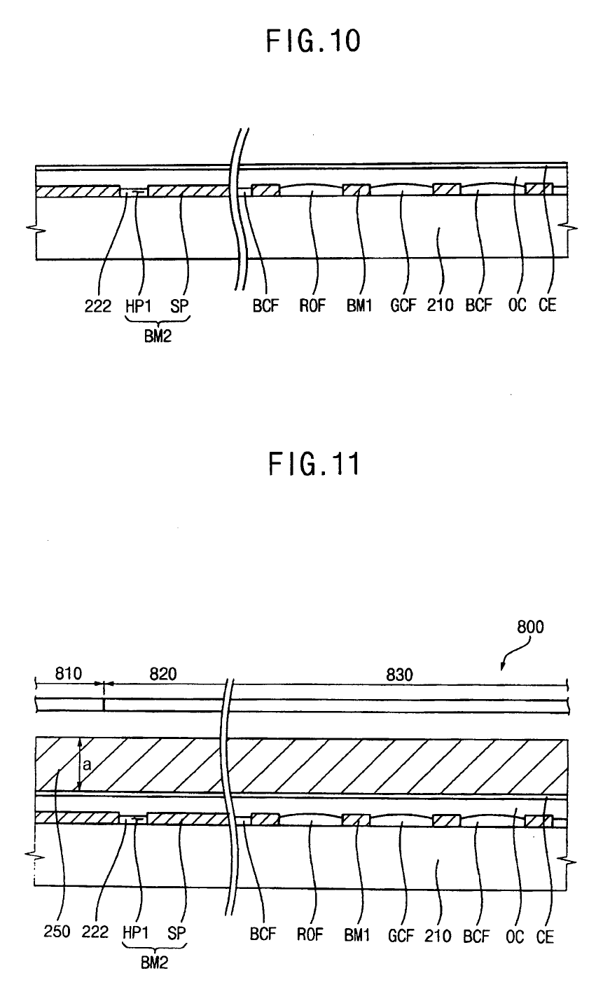

FIG. 10 is a cross-sectional view illustrating an embodiment of a process for forming the third color filters, the overcoating layer and the common electrode layer on the second base substrate.

Referring to FIGS. 3 and 10, the third color ink is injected onto the third pixel areas B of the second base substrate 210, on which the first and second color filters RCF and GCF are formed to form the third color filters BCF. The third color filters BCF are formed via substantially the same process as the first and second color filters RCF and GCF, and thus, any further repetitive explanation concerning the above elements will be omitted.

The third color ink is injected onto the third areas B and the third passage portion HP3 connecting the third pixel areas B with each other. Then, the overcoating layer OC and the common electrode layer CE are sequentially formed on the second base substrate 210, on which the first and second blocking patterns BM1 and BM2, and the first, second and third color filters RCF, GCF and BCF are formed. In one aspect, the overcoating layer OC may include acrylic resin, and the common electrode layer CE may include indium tin oxide (ITO) or indium zinc oxide (IZO).

FIG. 11 is a cross-sectional view illustrating an embodiment of a process for forming an organic layer on the second base substrate.

Referring to FIGS. 3 and 11, the organic layer 250 is formed on the second base substrate 210, on which the common electrode is formed.

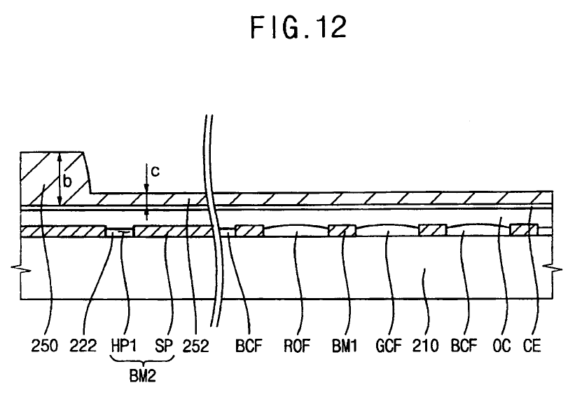

FIG. 12 is a sectional view illustrating an embodiment of a process for forming the organic pattern and the cell gap maintenance member on the second base substrate.

Referring to FIGS. 3 and 12, the organic layer 250 (shown in FIG. 11) is patterned to form the organic pattern 252 and the cell gap maintenance member CS. The organic layer 250 includes the organic material having color pigment. The organic layer 250 may include a negative type photoresist and a positive type photoresist. When light is irradiated onto the negative type photoresist, a portion of the negative type photoresist onto which the light is irradiated remains after a developing process. When light is irradiated onto the positive type photoresist, a portion of the positive type photoresist onto which the light is irradiated is removed through a developing process. In one aspect, color of the color pigment may be achromatic color such as black color, gray color and so on.

In one embodiment, a mask 800 is disposed on the second base substrate 210 on which the organic layer 250 is formed, and the light is irradiated onto the mask 800 to pattern the organic layer 250. The mask 800 includes a transmissive portion 810, a translucent portion 820 and a light blocking portion 830. The mask 800 may be designed according to a photosensitivity of the organic layer 250.

The light irradiated onto the mask 800 passes through the transmissive portion 810 of the mask 800 to be incident into the organic layer 250 and is blocked by the light blocking portion 830 of the mask 800. When the quantity of the light having passed through the transmissive portion 810 is defined as 100 and the quantity of light passing through the light blocking portion 830 is defined as 0, the quantity of light having passed through the translucent portion 820 of the mask 800 may be between about 0 and about 100. The translucent portion 820 may have a slit or a half tone.

The organic layer 250 corresponding to the light blocking portion 830 of the mask 800 is removed by a developing solution, and the organic layer 250 corresponding to the transmissive portion 810 and the translucent portion 820 of the mask 800 remains. The organic layer 250 corresponding to the transmissive portion 810 is patterned to form the cell gap maintenance member CS, and the organic layer 250 corresponding to the translucent portion 820 is patterned to form the organic pattern 252.

The thickness of the cell gap maintenance member CS is greater than that of the maintenance pattern 252. In one aspect, when the thickness of the organic layer 250 is a seventh thickness ‘a’, the thickness of the cell gap maintenance member CS is an eighth thickness b and that of the organic pattern 252 is a ninth thickness c. The eight thickness b of the cell gap maintenance member CS may be substantially same as the seventh thickness ‘a’ of the initial organic layer 250.

The organic pattern 252 covers the first, second and third passage portions HP1, HP2 and HP3 to prevent the light leakage of the backlight through the first, second and third passage portions HP1, HP2 and HP3. The organic pattern 252 may be formed via changing the design of the mask 800 in substantially the same process for forming the cell gap maintenance member CS without additional processes. Thus, the manufacturing costs may be decreased and the manufacturing process may be simplified. In addition, the cell gap maintenance member CS is connected to the organic pattern 252 so that the resistance against compression of the cell gap maintenance member CS between the array substrate 100 and the color filter substrate 200 may be enhanced. In one aspect, the cell gap maintenance member CS may be prevented from collapsing and may be easily restored after the external force is applied.

The color ink is sequentially injected onto the second base substrate 210 so that the thickness of the color filters adjacent to each other may be uniformly formed. Thus, uniformity of the adjacent color filters disposed along the second direction PW may be increased, and the display quality of the display panel may be enhanced. In one aspect, thickness uniformity of the adjacent color filters disposed along the second direction PW may be increased.

According to an embodiment of the invention, a passage portion of a second blocking pattern is formed so that a color ink may be sequentially injected, and an injected color ink may uniformly flow into an inner space formed by a first blocking pattern. Thus, the uniformity of the color filters may be increased.

In addition, an organic pattern covering the passage portion prevents light leakage through the passage portion, and resistance against compression of a cell gap maintenance member may be enhanced. Thus, the quality of the color filters and the reliability of a manufacturing process of a color filter substrate may be enhanced, and the display quality may be enhanced.

Having described embodiments of the invention and advantages thereof, it is noted that various changes, substitutions and alterations may be made herein without departing from the spirit and scope of the invention as defined by the appended claims.

What is claimed is:

1. A color filter substrate comprising:
a base substrate including a plurality of pixel areas;
a first blocking pattern extending along a first direction with respect to the base substrate;
a second blocking pattern crossing the first blocking pattern, and including a passage portion through which the base substrate is exposed to connect the pixel areas adjacent to each other along the first direction; and
a plurality of color filters formed in the pixel areas, respectively.

2. The color filter substrate of claim 1, wherein the second blocking pattern is formed in a first border between the color filters having substantially the same color, and wherein the color filters having substantially the same color are connected to each other through the passage portion.

3. The color filter substrate of claim 2, wherein the first blocking pattern is formed in a second border between the color filters having different colors.

4. The color filter substrate of claim 1, further comprising an organic pattern formed on the second blocking pattern, wherein the organic pattern has a first thickness corresponding to a thickness of the second blocking pattern and covers the passage portion.

5. The color filter substrate of claim 4, further comprising an overcoating layer formed between the base substrate having the first, second blocking patterns and the color filters and the organic pattern.

6. The color filter substrate of claim 5, further comprising a cell gap maintenance member connected to the organic pattern and formed on the second blocking pattern, wherein the cell gap maintenance member has a second thickness thicker than the first thickness.

7. The color filter substrate of claim 6, wherein the second blocking pattern comprises a cover portion corresponding to a switching element formed on an array substrate, and wherein the cell gap maintenance member is formed on the cover portion.

8. The color filter substrate of claim 5, further comprising a common electrode layer formed between the overcoating layer and the organic pattern.

9. A color filter substrate comprising:
a base substrate including a plurality of pixel areas;
a first blocking pattern extending along a first direction with respect to the base substrate;
a second blocking pattern having a dividing portion crossing the first pattern and a passage portion connected to the dividing portion and formed on the base substrate with a fourth thickness to connect the pixel areas adjacent to each other along the first direction; and
a plurality of color filters formed in the pixel areas, respectively.

10. The color filter substrate of claim 9, wherein the second blocking pattern is formed in a first border between the color filters having substantially the same color, and wherein the dividing portion has a third thickness thicker than the third thickness of the passage portion.

11. The color filter substrate of claim 10, wherein the first blocking pattern is formed in a second border between the color filters having different color and is thicker than the dividing portion of the second blocking pattern.

12. A method for manufacturing a color filter substrate, the method comprising:
forming a blocking layer on a base substrate having a plurality of pixel areas;
forming a first blocking pattern extending along a first direction via patterning the blocking layer;
forming a second blocking pattern including a passage portion, through which the base substrate is exposed to connect the pixel areas adjacent to each other along the first direction via patterning the blocking layer; and
forming a plurality of color filters in the pixel areas using a print head.

13. The method of claim 12, wherein the color filters are formed by sequentially injecting a color ink onto the pixel areas and the passage portion along the first direction using the print head.

14. The method of claim 13, wherein the color ink injected onto the passage portion connects the color filters adjacent to each other having substantially the same color.

15. The method of claim 14, wherein the color filters are formed by:
sequentially injecting a first color ink to form a plurality of first color filters; and
sequentially injecting a second color ink different from the first color ink to form a plurality of second color filters spaced apart from the first color filters.

16. The method of claim 12, further comprising:
forming an organic layer on the base substrate having the first and second blocking patterns and the color filters; and
forming an organic pattern having a first thickness via patterning the organic layer, the organic pattern corresponding to the second blocking pattern and covering the passage portion.

17. The method of claim 16, further comprising forming an overcoating layer under the organic layer.

18. The method of claim 17, wherein the organic pattern is formed by forming a cell gap maintenance member having a second thickness thicker than the first thickness via patterning the organic layer.

19. The method of claim 18, wherein the organic layer comprises an organic material having a color pigment.

20. The method of claim 17, further comprising forming a common electrode layer between the overcoating layer and the organic layer.
